(19) United States
(12) Patent Application Publication
(10) Pub. No.: US 2008/0187719 A1
(43) Pub. Date: Aug. 7, 2008

(54) NANO-IMPRINTING MOLD, METHOD OF MANUFACTURE OF NANO-IMPRINTING MOLD, AND RECORDING MEDIUM MANUFACTURED WITH NANO-IMPRINTING MOLD

(75) Inventor: Shinji UCHIDA, Tokyo (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD., Tokyo (JP)

(21) Appl. No.: 11/942,426

(22) Filed: Nov. 19, 2007

(30) Foreign Application Priority Data
Nov. 17, 2006 (JP) 2006-312058

(51) Int. Cl. B44C 1/00; B32B 3/00

(52) U.S. Cl. 428/156; 216/52; 425/470

(57) ABSTRACT

A mold is provide which, by using nano-imprinting, enables inexpensive provision of a magnetic recording medium capable of providing signals with a high signal intensity and enabling a high S/N. The method of the mold used in nano-imprinting includes: a transfer process of pressing a parent mold, having a relief pattern, against a resist layer formed on the surface of a substrate, and then releasing the parent mold to transfer the relief pattern to the resist layer; and a relief pattern formation process of exposing a lower substrate in depression portions of the resist in which the relief pattern has been formed by the transfer process, and etching the exposed substrate to form a relief pattern in the substrate, wherein in the relief pattern formation process, side etching of the substrate is performed during substrate etching.

### BACKGROUND

The invention relates to a nano-imprinting mold, to a method of manufacture of a nano-imprinting mold, and to a magnetic recording medium manufactured with a nano-imprinting mold.

Ever-finer resist patterns formed in the surfaces of substrates have been demanded with rising integration levels in the manufacture of information recording media and semiconductor devices. In the prior art, photolithography techniques have been used as methods for forming fine patterns in resist layers. In photolithography methods, a resist layer is exposed to light in order to form an exposure pattern. The resist layer is then subjected to development in order to form a pattern in the resist layer on the substrate.

In order to form finer patterns in resist layers, exposure light of increasingly shorter wavelengths has been used. In order to form fine resist patterns of 100 nm or below, electron beam (EB) lithography methods, which use electron beams as the exposure radiation, have emerged. However, EB lithography methods require expensive equipment, and because time is required to draw patterns, throughput is low, and therefore problems occur when trying to apply this process to mass production applications.

In recent years, a nano-imprinting method has been developed as a method for efficient forming of fine patterns (see for example U.S. Pat. No. 5,772,905), in which a method is disclosed for pressing a mold, on which a relief pattern is formed, onto a resist layer formed on the surface of a substrate. The pressing operation acts to transfer the relief pattern from the mold onto the resist film.

The procedures indicated by processes 1 through 4 in FIG. 1 are performed in the above-described nano-imprinting method. First, as shown in process 1, a mold 1 is prepared on a silicon substrate, on the surface of which a silicon oxide film is formed, by forming a relief pattern in the silicon oxide film using for example EB lithography. Alternatively, spin coating or another method can be used to prepare a substrate 3 on the surface of which is formed a resin film 2, such as for example polymethyl methacrylate (PMMA). Next, as shown in process 2, the resin film is softened at a temperature equal to or above the glass transition temperature (Tg) for the resin film (200° C. for PMMA, for which Tg=105° C.), and the mold is pressed onto the surface with a pressure of 13 MPa. Then, in process 3, after the temperature has fallen to below the temperature Tg of the resin film, the mold is separate from the resin film on the substrate. In this way, a relief pattern can be formed in the resin film on the substrate as shown in process 4. This method is generally called thermal nano-imprinting.

Recently, in place of a thermal cycle, a quartz glass mold and an UV-hardening resist film have been used in a method in which UV light irradiation is performed. This method is generally called UV nano-imprinting.

Normally, thereafter the procedure shown in process 5 through process 8 of FIG. 1 is performed to fabricate a device. Here, an example is shown of machining of a magnetic layer (magnetic recording layer) of a magnetic recording medium. First, as indicated in process 5, the remaining film in the depressions of the resin film in which the relief pattern is formed is removed by soft etching. Next, as indicated in processes 6 and 7, the pattern is used as a mask to perform dry etching of the surface of the magnetic recording medium. By patterning the magnetic layer of the magnetic recording medium as in process 8, discrete track media and pattern media are manufactured. In semiconductors, a resist mask is used with Si substrate or similar to form semiconductor devices by performing etching and CVD.

Further, in Japanese Patent Laid-open No. 2006-191089 (corresponding to U.S. Patent No. 2006-0144275 A1), a method is disclosed having a process of bringing an imprintable medium on a manufacturing template substrate into contact with a parent template and forming an imprint in the medium, a process of separating the medium from the parent template, a process of etching areas in which the thickness is reduced to expose regions of the manufacturing template substrate, and a process of etching the exposed regions to demarcate the manufacturing template.

There are two major problems when applying the above-described nano-imprinting methods to machining of discrete track media, patterned media, and semiconductor devices. One problem is that of the limit to pattern fineness. A second problem is the fact that molds fabricated by the EB lithography method are extremely expensive.

In current EB lithography methods, patterns as fine as 10 nm line widths over very small ranges of several mm are possible, but in the case of actual devices, the limit is a pattern width of 45 nm for areas of 10 mm on a side or more. This is because of the limit to focusing of an electron beam, because in fine patterning the power density is low and more time is required for patterning, and because as the patterning time is lengthened, shifts caused by external disturbances tend to occur. Particularly in the case of magnetic recording media, higher recording densities per unit area are being sought, and smaller relief pitches are better. Also, because signals are only obtained from protruding portions of the magnetic recording layer, protruding portions cannot be made smaller than necessary. Hence there is a need to make depressed portions in the magnetic recording layer as narrow as possible.

As explained above, in machining to form fine lines, the power density is low and machining times are lengthened, so that expensive EB equipment must be used for a long period of time. In mass produced products, molds must be replaced after several thousand to several million uses. This is because, in the course of repeated pattern transfers, molds are deformed and precision is degraded. Amortization costs for expensive molds are then added to the unit cost of the manufactured products.

In light of the above-described problems, it would be desirable to provide a mold which, by using nano-imprinting, enables inexpensive provision of a magnetic recording medium capable of providing signals with higher signal intensity and enabling higher S/N ratios, as well as to provide a manufacturing method and a magnetic recording medium manufactured using such a mold.

### SUMMARY OF THE INVENTION

The invention provides a mold which, by using nano-imprinting, enables inexpensive provision of a magnetic recording medium capable of providing signals with higher signal intensity and enabling higher S/N ratios The invention also provides a manufacturing method and a magnetic recording medium manufactured using such a mold.

Specifically, the invention provides a method of manufacture of a mold used in nano-imprinting that includes pressing a parent mold having a relief pattern against a resist layer formed on a surface of a substrate, releasing the parent mold to transfer the relief pattern to the resist layer, exposing the substrate in depression portions of the resist in which the relief pattern has been formed, and etching the exposed substrate to form a relief pattern in the substrate, wherein the etching includes side etching of the substrate.

The substrate may include a surface layer, and a layer which is located directly below the surface layer, and wherein the etching rate of the layer located directly below the surface layer is slower than the etching rate of the surface layer.

Preferably, the relief pattern of the parent mold includes protruding portions having a first width and the relief pattern in substrate includes protruding portions having a second width that is less than the first width.

The mold can be used to manufacture a variety of products including recording medium, and specifically magnetic recording medium. By means of this invention, when the protrusion lines of a child mold are made finer without changing the pitch, the ratio of the depression line width can be increased. This means that the ratio of protrusion line widths in the resist can be increased, and that the ratio of protrusion line widths in the magnetic recording medium can be raised, so that signals with a higher signal intensity can be obtained, and a higher S/N can be obtained.

### BRIEF DESCRIPTION OF THE DRAWINGS

The invention has been described with reference to certain preferred embodiments and the accompanying drawings, wherein:

FIG. 1 shows child mold manufacturing processes of the prior art;

FIG. 2 shows child mold manufacturing processes of an aspect of the invention;

FIG. 3 shows magnetic recording medium manufacturing processes using a child mold manufactured by a manufacturing method of an aspect of the invention;

FIG. 4 shows the child mold substrate and child mold used in Example 3;

FIG. 5 shows the child mold substrate and child mold used in Example 4; and

FIG. 6 is a photo showing an example of a scanning probe microscope (SPM) observation of the surface relief of a child mold in an embodiment of the invention.

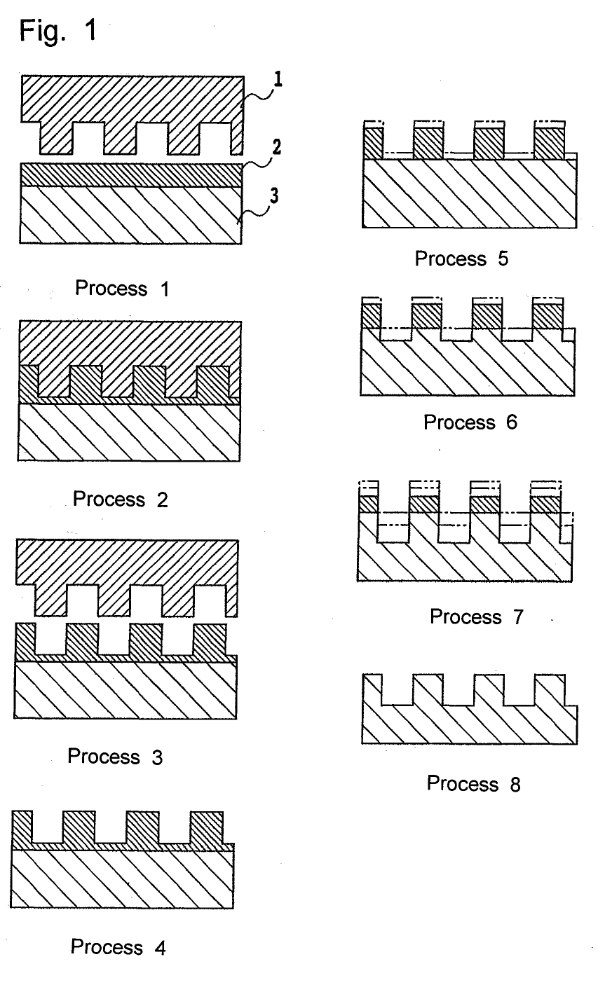

### DETAILED DESCRIPTION OF THE PREFERRED EMBODIMENTS

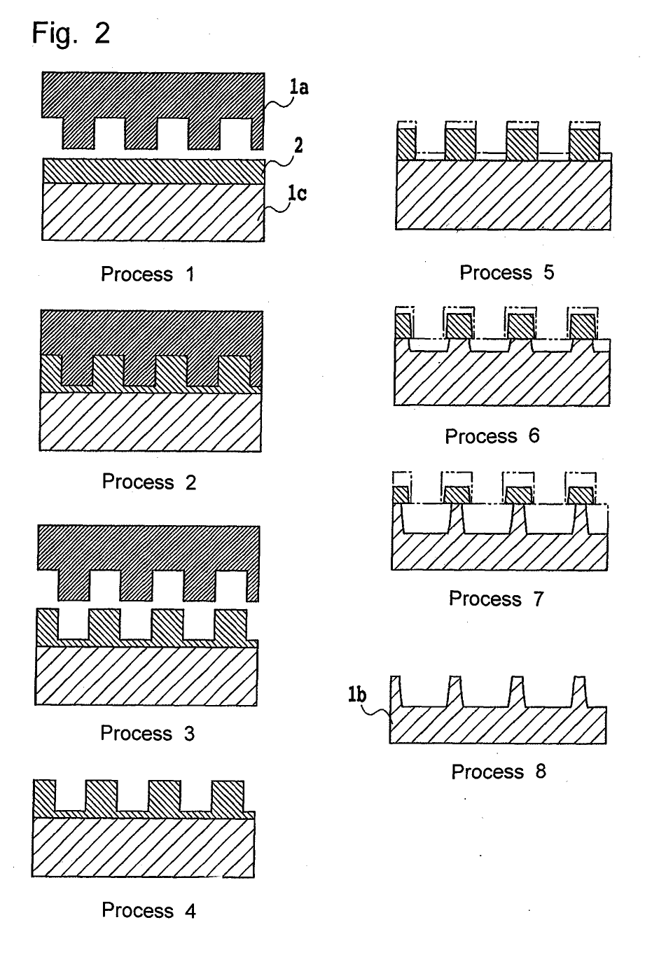

FIG. 2 is a process diagram showing one aspect of a mold manufacturing method of the invention. As shown in FIG. 2, a parent mold 1a is prepared first. The parent mold 1a, for example, is manufactured from a quartz glass mold. It is preferable that this mold be provided with a fine, high-density pattern; for example, it is preferable that the EB lithography method be used to form a pattern with line widths of 45 to 100 nm. It is preferable that a release film (not shown) be formed on the surface of this mold. For example, a compound which can be formed into a film and which has a hydrophobic group can be used for the release film.

A child mold substrate 1c, on the surface of which is deposited a resin film 2, is separately prepared. It is also preferable that a quartz glass substrate be used for the child mold substrate 1c. As shown in process 1 of FIG. 2, the surface of the parent mold 1a on which the relief pattern is formed is brought into opposition with and pressed against the resin face of the child mold substrate 1c. As shown in process 2 of FIG. 2, the resin is made to adapt to the relief pattern of the parent mold 1a to form the relief pattern in the resin surface of the child mold 1c. The resin is hardened in this state as shown in process 3 prior to the parent mold being separated, as shown in process 4. A child mold substrate is obtained with a resin film having the pattern transferred from the relief pattern of the parent mold.

Next, as shown in process 5, the resin film 2 remaining in the depression portions is removed to expose the substrate 1c. This removal of resin film can for example be performed using dry etching. At this time, so long as the substrate 1c is protected with the pattern maintained by the protruding portions of the resin 2, a portion of the upper portion of the resin film may be removed.

Next, the remaining resin film is used as a resist pattern to etch the substrate, for example using reactive etching, and in this way substrate etching is performed to form a relief pattern which is the inverse of that of the parent mold, as shown in processes 6 and 7. At this time, the side etch amount changes depending on the RF (high-frequency) power, reactive gas flow rate, vacuum pressure, etching time, etching temperature, and other etching conditions as will be well understood by those skilled in the art. Without side etching, etching is performed according to the molded resist pattern formed from parent mold 1a, such that the width of the protruding portions of the child mold will be substantially the same as the width of the protrusions of the parent mold. However, if side etching is employed, the space widths are increased, and line widths are decreased. In the present invention, the above-described conditions are controlled appropriately to obtain a prescribed side etching amount, and by this means the widths of protruding portions of the child mold can be reduced to a desired width that is less than the width of the protrusions formed in the parent mold.

Finally, as shown in process 8 of FIG. 2, for example plasma etching or a similar method is used to remove the remaining resin film, so that a child mold 1b is obtained in which the widths of protruding portions are decreased to the desired width.

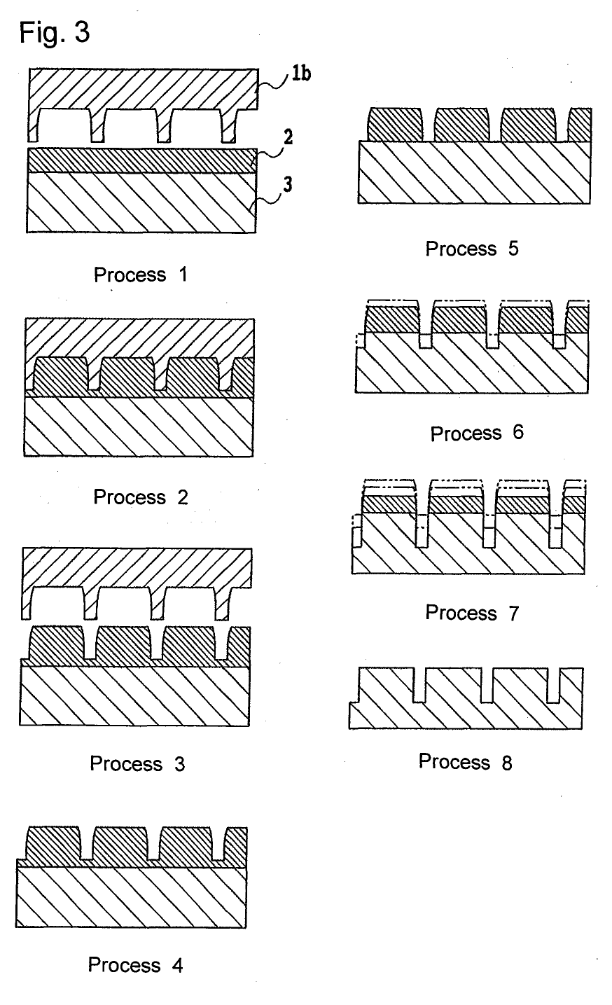

FIG. 3 shows processes for manufacture of a magnetic recording medium having a magnetic recording layer which has been patterned using a child mold of this invention. That is, by using this child mold 1b to perform nano-imprinting, followed by dry etching, to etch the surface of a magnetic recording medium substrate on which a magnetic recording layer has been uniformly deposited, a magnetic recording medium can be obtained having a magnetic recording layer which has been patterned with the line widths of the depression portions of the parent mold made finer.

Details of the process of etching of the surface of a magnetic recording medium substrate obtained by nano-imprinting and dry etching will now be explained. As shown in process 1 of FIG. 3, a child mold 1b obtained by the above processes is prepared. It is preferable that this mold be surface-treated using a release agent of the type described above. The material of the child mold need only be a material which is not deformed as a result of the temperature and pressure during stamping in thermal nano-imprinting. Also, in UV nano-imprinting, it is sufficient that the material transmit UV light. However, the protrusion portion material need not transmit UV light. This is because of UV light wraparound and resin wraparound.

More specifically, the child mold material may be poly dimethyl siloxane (PDMS), polyimide, polyamide, polycarbonate, an epoxy resin, or another polymer material; copper, nickel, tantalum, titanium, silicon, or an alloy of these; quartz glass or another glass material; silicon oxide (SiO₂), silicon carbide (SiC), carbon, sapphire, or another material. Also, a layered configuration of these may be used.

A substrate (magnetic recording medium substrate) 3 on the surface of which a resin film 2 is deposited is separately prepared. Then, as shown in process 2 of FIG. 3, the surface of the child mold 1b on which the relief pattern is formed is placed in opposition to and pressed against the resin surface of the resin-coated substrate 3. The resin 2 is made to adapt to the relief pattern of the child mold, to form the relief pattern in the resin surface of the resin-coated substrate. The resin is then hardened in this state as shown in process 3. The child mold is then separated and, as shown in process 4, a resin-coated substrate is obtained with a resin film having the pattern transferred from the relief pattern of the child mold. The material of the resin film may be polymethyl methacrylate (PMMA) or another thermoplastic resin, or epoxy or another thermosetting resin. In UV nano-imprinting, a UV-hardening resin is sufficient.

Next, the resin film remaining in the depression portions is removed, and as shown in process 5 of FIG. 3, the substrate 3 is exposed. Dry etching can be used, for example, for the removal of the resin film. At this time, so long as the substrate is protected while maintaining the pattern by the protruding portions of the resin, a portion of the upper portion of the resin film may be removed.

Next, reactive etching for example is used to etch the magnetic recording layer of the substrate, with the remaining resin film used as a resist pattern. Accordingly, the magnetic recording layer of the substrate is etched so as to form a relief pattern opposite that of the child mold 1b, as shown in processes 6 and 7. By removing the remaining resin film, a magnetic recording medium in which the magnetic recording layer is patterned is obtained as shown in process 8.

When the child mold substrate comprises two or more layers, if the layer directly beneath the surface layer is a layer with a slower etching rate than the surface layer, then during etching of the child substrate, it is possible to etch only the surface layer, so that the layer directly beneath the surface layer is not etched at all; as a result, the depression portion bottom faces of the child mold after etching can be made clean, flat surfaces, and a resin film (resist film) formed using this child mold has protruding portions with no sagging, with flat protruding-portion surfaces, and high dimensional precision. As a result, the pattern precision of the magnetic recording medium can be enhanced.

### EXAMPLE 1

First, a quartz glass parent mold 1a was prepared as shown in process 1 of FIG. 2. As this parent mold 1a, an EB photolithography method was employed, in which resist was applied to the surface of quartz glass and EB exposure was used to form a pattern, after which dry etching was performed to form a relief pattern in the quartz glass; by this means a quartz glass mold for discrete track media was fabricated having concentric lines and spaces with line widths of 80 nm, space widths of 80 nm, and depths of 100 nm, as well as servo information pattern in some portions, over the entire surface of a donut-shaped disc of outer diameter 65 mm and inner diameter 20 mm. This parent mold was subjected to release film formation treatment to form a monolayer release film on the parent mold surface, by heating, evaporating, and causing a polymer-structure thin film material having a water-repellent base to be evaporation-deposited onto and react with the substrate surface in vacuum.

As shown in process 1 of FIG. 2, a quartz glass child mold 1c onto which a resin film 2 was deposited was prepared. The resin film 2 was formed by spin coating a UV-hardening resin (Toyo Gosei PAK-01) to a thickness of 50 to 100 nm, and then baking at 80° C. Next, as shown in process 2 of FIG. 2, the parent mold 1a was pressed with a pressure of 0.1 MPa against the quartz glass child mold substrate 1c on which the resin film 2 is formed and pressing was performed, and the resin was made to adapt to the mold relief pattern. While in this state, UV light irradiation was performed for 10 seconds. Next, as shown in process 3 of FIG. 2, the mold was released from the substrate, and as in process 4 of FIG. 2, a quartz glass child mold substrate 1c having a resin film with a pattern transferred from the relief pattern of the parent mold was fabricated. Next, as shown in process 5 of FIG. 2, dry etching was performed using oxygen plasma, to remove the resin film remaining in the depression portions and expose the substrate in the depression portions. 0034]A reactive ion etching (RIE) device is then used to perform dry etching of the depression portions of the quartz glass substrate with CHF₃ gas, as in processes 6 and 7 in FIG. 2. At this time, side etching was performed during etching with the RF power, gas flow rate, vacuum pressure, etching time, temperature, and other etching conditions as follows. CHF₃ was used as the deposition gas with C₄F₈ added, and the RF power was 200 W, the bias was 30 W, and the vacuum pressure was 0.01 to 10 Pa; etching was performed in particular at 0.1 to 1 Pa and a temperature of −40 to 50° C., and at −10 to 25° C., over an etching time of 10 seconds to 3 minutes.

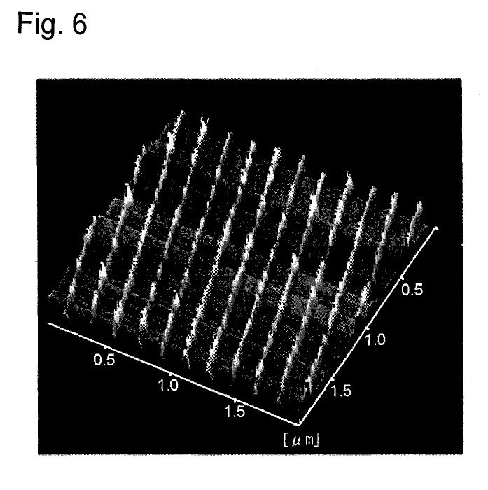

Finally, as shown in process 8 in FIG. 2, etching using oxygen plasma was employed to remove the remaining resist, to fabricate a child mold 1b with a fine pattern taken from the parent mold, having lines of width 40 nm and spaces of width 120 nm. FIG. 6 shows an observation image obtained by scanning probe microscope (SPM). In FIG. 6, the pattern depth is 100 nm, and the line widths and space widths at the 50 nm depth position are 40 nm and 120 nm respectively.

Next, using the above child mold 1b, nano-imprinting and dry etching were performed to etch the surface of a magnetic recording medium substrate, as shown in FIG. 3. As shown in process 1 of FIG. 3, a child mold 1b was prepared. The child mold 1b was fabricated using the above-described processes; concentric lines and spaces with line widths of 40 nm, space widths of 120 nm, and depths of 100 nm, as well as a servo information pattern in some portions, were formed over the entire surface of a donut-shaped disc of outer diameter 65 mm and inner diameter 20 mm. After the above processes, vapor-phase release film formation was performed. Further, a substrate 3 on which a resin film 2 was formed (here, a magnetic recording medium substrate on which a magnetic recording layer is deposited uniformly) was prepared. The resin film 2 was UV-hardening resin (Toyo Gosei PAK-01), applied by spin coating to a thickness of 50 to 100 nm and baked at 80° C.

As indicated in process 2 of FIG. 3, the child mold 1b was pressed at a pressure of 0.1 MPa against the substrate 3 on which the resin film 2 is formed, and pressing was performed, causing the resin to adapt to the mold relief pattern. In this state, UV irradiation for 10 seconds was performed. Next, as shown in process 3 of FIG. 3, the child mold was released from the substrate, so that, as in process 4 of FIG. 3, a substrate was fabricated with a resin film having a pattern transferred from the relief pattern of the child mold. Next, as indicated in process 5 of FIG. 3, by performing dry etching using oxygen plasma, the resin film remaining in the depression portions was removed. Next, as indicated in processes 6 and 7 of FIG. 3, protruding portions of the resin film formed in the pattern were used as a mask to perform etching of the surface of the magnetic recording medium substrate using reactive ion etching (RIE) equipment, employing chlorine gas, under conditions such that side etching did not occur; as shown in process 8 of FIG. 3, a magnetic recording medium was thus fabricated having a machined shape with lines of width 120 nm and spaces of width 40 nm in the magnetic recording layer on the surface. By this means, a width of 40 nm, which cannot easily be attained by methods of the prior art, was achieved. Finally, CVD was used to form a diamond-like carbon (DLC) film, and a lubricating film was applied by dipping.

In this way, a discrete track medium was fabricated, with a relief pattern of lines and spaces in concentric circles having line widths of 120 nm and space widths of 40 nm, and of servo information patterns in some portions, formed over the entire surface of a donut-shaped disc of outer diameter 65 mm and inner diameter 20 mm.

### EXAMPLE 2

Using the method of Example 1, and employing a child mold with the line width to space width ratio varied, at a pitch of 160 nm and both under conditions with no side etching and under three sets of conditions to cause side etching, four types of discrete track media were fabricated with the line width/space width set to 80 nm/80 nm, 100 nm/60 nm, 120 nm/40 nm, and 140 nm/20 nm. The discrete track media thus fabricated were evaluated by measuring on-track magnetic recording signals. As a result, signals could be obtained from all four types of media. The larger the line width, the stronger were the signals, and satisfactory S/N ratios could be obtained.

### EXAMPLE 3

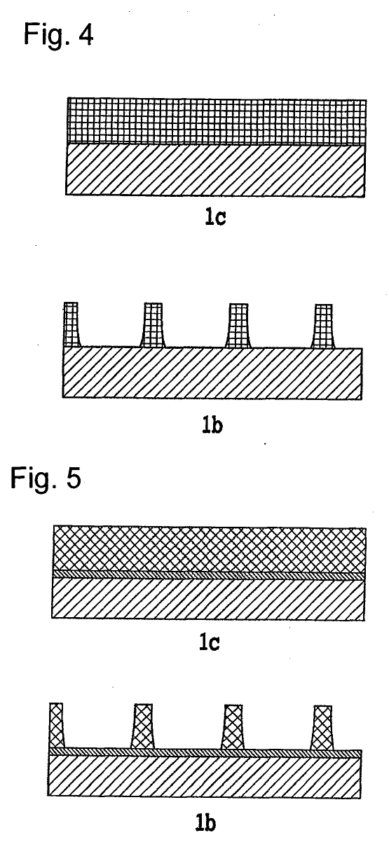

As shown in FIG. 4, a child mold was fabricated similarly to Embodiment 1, using a child mold substrate 1c prepared by sputter deposition of Ti film onto the surface of quartz glass to a thickness of 100 nm. SF6 was used as the etching gas. Etching of only the Ti film was performed, stopping at the quartz glass surface; satisfactory flat planes were obtained at the bottom portions of the depressions. Upon using this mold, similarly to Example 1, to perform nano-imprinting of a resist film (resin film) 2, a pattern with high dimensional precision could be obtained, with no sagging at the protruding portions of the resist film.

### EXAMPLE 4

As shown in FIG. 5, other than using a child mold substrate 1c prepared by depositing an Al film 10 nm on the surface of quartz glass, and then depositing a 100 nm SiO₂ thereupon, the same method as in Embodiment 1 was used to fabricate a child mold. As the etching gas, CHF₃ was used. In this case also, etching of only the SiO₂ film was performed, and etching was stopped at the Al film surface; satisfactory flat surfaces in the bottom portions of depressions were obtained. Using this child mold, a resist film (resin films) 2 was nano-imprinted similarly to Embodiment 1, and a pattern with high dimensional precision, with no sagging of protruding portions of the resist film, could be obtained.

By means of this invention, a child mold can be manufactured simply, with fine detail, and with good precision. Consequently the lifetime of expensive parent molds can be extended, and the impact on product unit costs can be reduced. Further, a pattern which is finer and more precise than the pattern of the parent mold can be obtained. Hence through application to fabrication of semiconductor devices, and to machining of discrete track media, patterned media, and other magnetic recording media, fine-machined devices can be manufactured with fine detail and to high precision using nano-imprinting.

The invention has been described with reference to certain preferred embodiments thereof. It will be understood, however, that modifications and variations are possible within the scope of the appended claims. For example, although the invention has been described specifically with reference to the manufacture of magnetic recording medium, the invention is also applicable to other types of recording medium, such as optical medium, in which tracks are formed in a recording medium substrate. Further, while the preferred embodiments refer to resist and resin layers, in other applications the relief layer, namely, the layer being pressed may be comprised of other materials.

What is claimed is:

1. A method of manufacture of a mold used in nano-imprinting, comprising:
pressing a parent mold having a relief pattern against a resist layer formed on a surface of a substrate of a child mold;
releasing the parent mold to transfer the relief pattern to the resist layer;
exposing the substrate in depression portions of the resist in which the relief pattern has been formed; and
etching the exposed substrate to form a relief pattern in the substrate, wherein the etching includes side etching of the substrate.

2. The method of manufacture of a mold according to claim 1, wherein the substrate comprises a surface layer, and a layer which is located directly below the surface layer, and wherein the etching rate of the layer located directly below the surface layer is slower than the etching rate of the surface layer.

3. The method of manufacture of a mold according to claim 1, wherein the relief pattern of the parent mold includes protruding portions having a first width and the relief pattern in substrate includes protruding portions having a second width that is less than the first width.

4 A nano-imprinting mold. manufactured by the process of:
pressing a parent mold having a relief pattern against a resist layer formed on a surface of a substrate a child mold;
releasing the parent mold to transfer the relief pattern to the resist layer;
exposing the substrate in depression portions of the resist in which the relief pattern has been formed; and
etching the exposed substrate to form a relief pattern in the substrate, wherein the etching includes side etching of the substrate.

5. The nano-imprinting mold according to claim 4, wherein the substrate comprises a surface layer, and a layer which is located directly below the surface layer, and wherein the etching rate of the layer located directly below the surface layer is slower than the etching rate of the surface layer.

6. The nano-imprinting mold according to claim 4, wherein the relief pattern of the parent mold includes protruding portions having a first width and the relief pattern in substrate includes protruding portions having a second width that is less than the first width.

7 A method of manufacturing a recording medium comprising:
forming a resin layer on a substrate;
pressing a nano-imprinting mold including a relief pattern into the resin layer formed on the substrate;
releasing the nano-imprinting mold to transfer the relief pattern of the nano-imprinting mold into the resin layer;
exposing the substrate in depression portions of the resin layer which the relief pattern has been formed; and
etching the exposed substrate to form a pattern therein;
wherein the nano-imprinting mold comprises a non-imprinting mold manufactured by the process of:
pressing a parent mold having a relief pattern against a resist layer formed on a surface of a child mold substrate;
releasing the parent mold to transfer the relief pattern to the resist layer;
exposing the child mold substrate in depression portions of the resist in which the relief pattern has been formed;
etching the exposed child mold substrate to form a relief pattern in the child mold substrate, wherein the etching includes side etching of the child mold substrate.

8. The method of manufacturing a recording medium according to claim 7, wherein the child mold substrate comprises a surface layer, and a layer which is located directly below the surface layer, and wherein the etching rate of the layer located directly below the surface layer is slower than the etching rate of the surface layer.

9. The method of manufacturing a recording medium according to claim 7, wherein the relief pattern of the parent mold includes protruding portions having a first width and the relief pattern in child mold substrate includes protruding portions having a second width that is less than the first width.

10. The method of manufacturing a recording medium according to claim 7, wherein the pattern formed in the substrate has a line width from 80 to 120 nm.

11. The method of manufacturing a recording medium according to claim 7, wherein the pattern formed in the substrate has space widths from 20 to 80 nm.

12. The method of manufacturing a recording medium according the claim 7, wherein the pattern formed in the substrate has a line/space width of one of 80 nm/80 nm, 100 nm/60 nm, 120 nm/40 nm, and 140 nm/20 nm.

13. The method of manufacturing a recording medium according to claim 7, wherein the substrate is a magnetic recording substrate.

14 A recording medium manufactured by the process of:
forming a resin layer on a substrate;
pressing a nano-imprinting mold including a relief pattern into the resin layer formed on the substrate;
releasing the nano-imprinting mold to transfer the relief pattern of the nano-imprinting mold into the resin layer;
exposing the substrate in depression portions of the resin layer which the relief pattern has been formed; and
etching the exposed substrate to form a pattern therein;
wherein the nano-imprinting mold comprises a non-imprinting mold manufactured by the process of:
pressing a parent mold having a relief pattern against a resist layer formed on a surface of a child mold substrate;
releasing the parent mold to transfer the relief pattern to the resist layer;
exposing the child mold substrate in depression portions of the resist in which the relief pattern has been formed;
etching the exposed child mold substrate to form a relief pattern in the child mold substrate, wherein the etching includes side etching of the child mold substrate.

15. The recording medium according to claim 14, wherein the child mold substrate comprises a surface layer, and a layer which is located directly below the surface layer, and wherein the etching rate of the layer located directly below the surface layer is slower than the etching rate of the surface layer.

16. The recording medium according to claim 14, wherein the relief pattern of the parent mold includes protruding portions having a first width and the relief pattern in child mold substrate includes protruding portions having a second width that is less than the first width.

17. The recording medium according to claim 14, wherein the pattern formed in the substrate has a line width from 80 to 120 nm.

18. The recording medium according to claim 14, wherein the pattern formed in the substrate has space widths from 20 to 80 nm.

19. The recording medium according the claim 14, wherein the pattern formed in the substrate has a line/space width of one of 80 nm/80 nm, 100 nm/60 nm, 120 nm/40 nm, and 140 nm/20 nm.

20. The recording medium according claim clam 14, wherein the substrate is a magnetic recording substrate.
